(19) United States
(12) Patent Application Publication
(10) Pub. No.: US 2025/0293431 A1
(43) Pub. Date: Sep. 18, 2025

(54) ARRAY ANTENNA AND METHOD FOR MANUFACTURING ARRAY ANTENNA

(71) Applicant: HUAWEI TECHNOLOGIES CO., LTD., Shenzhen (CN)

(72) Inventors: Tao WAN, Chengdu (CN); Qiao LIU, Chengdu (CN); Guangjian WANG, Chengdu (CN); Kuandong GAO, Shenzhen (CN)

(21) Appl. No.: 19/221,636

(22) Filed: May 29, 2025

Related U.S. Application Data
(63) Continuation of application No. PCT/CN2022/135196, filed on Nov. 29, 2022.

(51) Int. Cl. H01Q 3/30; H01Q 21/08

(52) U.S. Cl. CPC H01Q 3/30; H01Q 21/08

(57) ABSTRACT

An array antenna are provided, to estimate a large quantity of DOAs. The array antenna includes N array elements disposed in a same direction, and N is an integer greater than or equal to 3. A spacing between an i^{th} array element in the N array elements and a reference position in the direction is Mᵢ times a unit length, and i is any integer from 1 to N. Half wavelengths of the N array elements are the same, and the unit length is a positive integer multiple of the half wavelength. The N array elements are in one-to-one correspondence with N positive integers, any two of the N positive integers are prime numbers of each other, Mᵢ is a product of N-1 positive integers, and the N-1 positive integers are integers other than a positive integer corresponding to the i^{th} array element in the N positive integers.

### CROSS-REFERENCE TO RELATED APPLICATIONS

This application is a continuation of International Application No. PCT/CN2022/135196, filed on Nov. 29, 2022, the disclosure of which is hereby incorporated by reference in its entirety.

### TECHNICAL FIELD

This application relates to the communication field, and in particular, to an array antenna and a method for manufacturing an array antenna.

### BACKGROUND

Currently, there are roughly two forms of array antennas: a uniform linear array antenna, and a non-uniform linear array antenna like a coprime array antenna. A maximum quantity of directions of arrival (DOAs) that can be estimated by the uniform linear array antenna, or a quantity of received beams is a quantity of array elements of the uniform linear array antenna minus 1. Compared with the uniform linear array antenna, the non-uniform linear array antenna has a higher degree of freedom in spatial spectrum estimation, and can estimate more DOAs. A coprime array antenna including six array elements is used as an example. Because the coprime array antenna has a large array element spacing, the coprime array antenna may be equivalent to a uniform linear array antenna including 13 array elements, so that a maximum of 12 DOAs can be estimated.

However, with development of technologies, future communication may require higher performance of an array antenna, and require a higher degree of freedom in spectrum estimation, that is, a large quantity of DOAs needs to be estimated. A current coprime array antenna cannot meet this requirement.

### SUMMARY

Embodiments of this application provide an array antenna and a method for manufacturing an array antenna, to estimate a large quantity of DOAs.

To achieve the foregoing objective, this application uses the following technical solutions.

According to a first aspect, an array antenna is provided. The array antenna includes N array elements disposed in a same direction, and N is an integer greater than or equal to 3. A spacing between an i^{th} array element in the N array elements and a reference position in the direction is Mᵢ times a unit length, and i is any integer from 1 to N. Half wavelengths of the N array elements are the same, and the unit length is a positive integer multiple of the half wavelength. The N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

It can be learned from the array antenna according to the first aspect that, because the spacing between the i^{th} array element and the reference position is a unit length multiplied by the product of the N−1 positive integers, in other words, a unit length multiplied by a product of at least two positive integers. Compared with a conventional coprime array antenna, the array antenna includes array antennas with an increased array element spacing, where the array elements may be disposed more sparsely. Therefore, the array antenna may be equivalent to a linear array antenna with more array elements, for example, a uniform linear array antenna, to estimate a large quantity of DOAs.

In a possible design solution, the N array elements include a first array element, a second array element, and a third array element. A spacing between the first array element and the reference position is M₁ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, M₁ is a product of J₂ and J₃, M₂ is a product of J₁ and J₃, M₃ is a product of J₁ and J₂, and any two integers in J₁, J₂, and J₃ are prime numbers of each other. This ensures that positions of the array elements may not overlap each other, so that performance of the array antenna can be improved, and more DOAs can be estimated.

Optionally, a product of J₁, J₂, and J₃ is positively correlated with a quantity of beams of the array antenna, and the quantity of beams of the array antenna is a quantity of beams transmitted or received by the array antenna. For example, the product of J₁, J₂, and J₃ is positively correlated with a quantity of array elements of a linear array equivalent to the array antenna, and the quantity of array elements of the linear array is positively correlated with the quantity of beams of the array antenna. The quantity of array elements of the linear array is K, and that the product of J₁, J₂, and J₃ is positively correlated with the quantity of array elements of the linear array means that K=2*J₁*J₂*J₃+1. On this basis, that the quantity of array elements of the linear array is positively correlated with the quantity of beams of the array antenna means that the quantity of beams of the array antenna is K-1.

It may be understood that values of J₁, J₂, and J₃ may usually determine a quantity of array elements of the array antenna. For example, the quantity of array elements of the array antenna is J₁+J₂+J₃-2. In other words, only several array elements, for example, J₃ array elements, are added, so that the quantity of array elements of the equivalent linear array can exponentially increase, for example, increase by nearly J₃ times. In this way, the quantity of beams of the array antenna can also increase exponentially, so that a quantity of estimated DOAs significantly increases.

Optionally, values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7, to form different forms of array antennas, and meet various actual application requirements.

According to a second aspect, an array antenna is provided. The array antenna includes a first array element, a second array element, and a third array element that are disposed in a first direction. Half wavelengths of the first array element, the second array element, and the third array element are the same, a spacing between the first array element and a reference position in the first direction is M₁ times the half wavelength, a spacing between the second array element and the reference position is M₂ times the half wavelength, a spacing between the third array element and the reference position is M₃ times the half wavelength, M₁ is a product of J₂ and J₃, M₂ is a product of J₁ and J₃, and M₃ is a product of J₁ and J₂, and any two integers in J₁, J₂, and J₃ are prime numbers of each other.

In a possible design solution, a product of J₁, J₂, and J₃ is positively correlated with a quantity of beams of the array antenna, and the quantity of beams of the array antenna is a quantity of beams transmitted or received by the array antenna. For example, the product of J₁, J₂, and J₃ is positively correlated with a quantity of array elements of a linear array equivalent to the array antenna, and the quantity of array elements of the linear array is positively correlated with the quantity of beams of the array antenna.

Optionally, the quantity of array elements of the linear array is K, and that the product of J₁, J₂, and J₃ is positively correlated with the quantity of array elements of the linear array means that K=2*J₁*J₂*J₃+1. In this case, that the quantity of array elements of the linear array is positively correlated with the quantity of beams of the array antenna means that the quantity of beams of the array antenna is K-1.

Optionally, the array antenna further includes a fourth array element disposed at the reference position.

In a possible design solution, values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

In addition, for technical effects of the array antenna according to the second aspect, refer to the technical effects of the array antenna according to the first aspect. Details are not described herein again.

According to a third aspect, an array antenna is provided. The array antenna includes N array elements disposed in a same direction, and N is an integer greater than or equal to 3. A spacing between an i^{th} array element in the N array elements and a reference position in the direction is Mᵢ times a unit length, and i is any integer from 1 to N. Half wavelengths of the N array elements are the same, and the unit length is a positive integer multiple of the half wavelength. The N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

Optionally, a product of the N positive integers is positively correlated with a quantity of beams of the array antenna, and the quantity of beams of the array antenna is a quantity of beams transmitted or received by the array antenna. For example, the product of the N positive integers is positively correlated with a quantity of array elements of a linear array equivalent to the array antenna, and the quantity of array elements of the linear array is positively correlated with the quantity of beams of the array antenna.

Further, the quantity of array elements of the linear array is two times the product of the N positive integers plus 1. In this case, the quantity of beams of the array antenna is two times the product of the N positive integers.

Optionally, values of the N positive integers meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

In addition, for technical effects of the array antenna according to the third aspect, refer to the technical effects of the array antenna according to the first aspect. Details are not described herein again.

According to a fourth aspect, a method for manufacturing an array antenna is provided. The method includes: obtaining N array elements of the array antenna, and disposing the N array elements in a same direction. N is an integer greater than or equal to 3. A spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

In a possible design solution, the N array elements include a first array element, a second array element, and a third array element, and the disposing the N array elements in a same direction includes: disposing the first array element, the second array element, and the third array element in the same direction. A spacing between the first array element and the reference position is M₁ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, M₁ is a product of J₂ and J₃, M₂ is a product of J₁ and J₃, M₃ is a product of J₁ and J₂, and any two integers in J₁, J₂, and J₃ are prime numbers of each other.

Optionally, a product of J₁, J₂, and J₃ is positively correlated with a quantity of beams of the array antenna, and the quantity of beams of the array antenna is a quantity of beams transmitted or received by the array antenna. For example, the product of J₁, J₂, and J₃ is positively correlated with a quantity of array elements of a linear array equivalent to the array antenna, and the quantity of array elements of the linear array is positively correlated with the quantity of beams of the array antenna.

Further, the quantity of array elements of the linear array is K, and that the product of J₁, J₂, and J₃ is positively correlated with the quantity of array elements of the linear array means that K=2*J₁*J₂*J₃+1. In this case, that the quantity of array elements of the linear array is positively correlated with the quantity of beams of the array antenna means that the quantity of beams of the array antenna is K-1.

Optionally, values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

In addition, for technical effects of the method according to the fourth aspect, refer to the technical effects of the array antenna according to the first aspect. Details are not described herein again.

According to a fifth aspect, a chip is provided. The chip includes a transceiver and the array antenna according to any one of the first aspect to the third aspect. The array antenna is connected to the transceiver.

In a possible design solution, there are a plurality of array antennas, and the plurality of array antennas are disposed in different directions, to estimate a spatial DOA.

In a possible design solution, the transceiver may be a transceiver circuit or an interface circuit.

In a possible design solution, the chip in the fifth aspect may be a radio frequency chip, a processing chip, or any other possible chip. This is not limited.

In addition, for technical effects of the chip according to the fifth aspect, refer to the technical effects of the array antenna according to the first aspect. Details are not described herein again.

According to a sixth aspect, a communication apparatus is provided, and includes a processor and the array antenna according to any one of the first aspect to the third aspect. The array antenna is connected to the processor.

In a possible design solution, there are a plurality of array antennas, and the plurality of array antennas are disposed in different directions, to estimate a spatial DOA.

In a possible design solution, the communication apparatus may further include a transceiver connected to the array antenna. The transceiver may be a transceiver circuit or an interface circuit.

In a possible design solution, the communication apparatus according to the sixth aspect may further include a memory. The memory and the processor may be integrated together, or may be disposed separately.

According to a seventh aspect, a communication apparatus is provided. The communication apparatus includes a processor. The processor is configured to perform the method according to the fourth aspect.

In a possible design solution, the communication apparatus according to the seventh aspect may further include a transceiver. The transceiver may be a transceiver circuit or an interface circuit. The transceiver may be used by the communication apparatus according to the seventh aspect to communicate with another communication apparatus.

In a possible design solution, the communication apparatus according to the seventh aspect may further include a memory. The memory and the processor may be integrated together, or may be disposed separately. The memory may be configured to store a computer program and/or data related to the method according to the fourth aspect.

In addition, for technical effects of the communication apparatus according to the seventh aspect, refer to the technical effects of the array antenna according to the first aspect. Details are not described herein again.

According to an eighth aspect, a communication apparatus is provided. The communication apparatus includes a processor. The processor is coupled to a memory, and the processor is configured to execute a computer program stored in the memory, to enable the communication apparatus to perform the method according to the fourth aspect.

In a possible design solution, the communication apparatus according to the eighth aspect may further include a transceiver. The transceiver may be a transceiver circuit or an interface circuit. The transceiver may be used by the communication apparatus according to the eighth aspect to communicate with another communication apparatus.

In addition, for technical effects of the communication apparatus according to the eighth aspect, refer to the technical effects of the array antenna according to the first aspect. Details are not described herein again.

According to a ninth aspect, a communication apparatus is provided, and includes a processor and a memory. The memory is configured to store a computer program. When the processor executes the computer program, the communication apparatus is enabled to perform the method according to the fourth aspect.

In a possible design solution, the communication apparatus according to the ninth aspect may further include a transceiver. The transceiver may be a transceiver circuit or an interface circuit. The transceiver may be used by the communication apparatus according to the ninth aspect to communicate with another communication apparatus.

In addition, for technical effects of the communication apparatus according to the ninth aspect, refer to the technical effects of the array antenna according to the first aspect. Details are not described herein again.

According to a tenth aspect, a computer-readable storage medium is provided, and includes a computer program or instructions. When the computer program or the instructions are run on a computer, the computer is enabled to perform the method according to the fourth aspect.

According to an eleventh aspect, a computer program product is provided, and includes a computer program or instructions. When the computer program or the instructions are run on a computer, the computer is enabled to perform the method according to the fourth aspect.

According to a twelfth aspect, an antenna panel is provided. The antenna panel includes a plurality of array antennas according to any one of the first aspect to the third aspect.

In a possible design solution, plurality of the array antennas are disposed in different directions.

In addition, for technical effects of the antenna panel in the twelfth aspect, refer to the technical effects of the array antenna according to the first aspect. Details are not described herein again.

According to a thirteenth aspect, a chip or a chip system is provided, where the chip or the chip system includes an input/output interface and a processing circuit. The input/output interface is configured to exchange information or data, and the processing circuit is configured to run instructions, to enable an apparatus on which the chip or the chip system is installed to perform the method according to the fourth aspect.

### BRIEF DESCRIPTION OF DRAWINGS

FIG. 1 is a diagram of a structure of a uniform linear array antenna;

FIG. 2 is a diagram of a quantity of beams of a uniform linear array antenna;

FIG. 3 is a diagram 1 of a structure of a coprime array antenna;

FIG. 4 is a diagram 2 of a structure of a coprime array antenna;

FIG. 5 is a diagram 1 of a structure of a communication apparatus according to an embodiment of this application;

FIG. 6 is a diagram 2 of a structure of a communication apparatus according to an embodiment of this application;

FIG. 7 is a diagram 1 of a structure of an array antenna according to an embodiment of this application;

FIG. 8 is a diagram 2 of a structure of an array antenna according to an embodiment of this application;

FIG. 9 is a diagram 3 of a structure of an array antenna according to an embodiment of this application;

FIG. 10 is a diagram 4 of a structure of an array antenna according to an embodiment of this application;

FIG. 11 is a diagram 5 of a structure of an array antenna according to an embodiment of this application;

FIG. 12 is a diagram 6 of a structure of an array antenna according to an embodiment of this application;

FIG. 13 is a diagram 7 of a structure of an array antenna according to an embodiment of this application;

FIG. 14 is a diagram 8 of a structure of an array antenna according to an embodiment of this application;

FIG. 15 is a diagram 9 of a structure of an array antenna according to an embodiment of this application;

FIG. 16 is a diagram 10 of a structure of an array antenna according to an embodiment of this application;

FIG. 17(a), FIG. 17(b), FIG. 17(c), FIG. 17(d), and FIG. 17(e) are a diagram 1 of simulation of an array antenna according to an embodiment of this application;

FIG. 18(a), FIG. 18(b), FIG. 18(c), FIG. 18(d), and FIG. 18(e) are a diagram 2 of simulation of an array antenna according to an embodiment of this application;

FIG. 19 is a diagram of a structure of an array antenna according to an embodiment of this application;

FIG. 20 is a schematic flowchart of a method for manufacturing an array antenna according to an embodiment of this application; and

FIG. 21 is a diagram of a structure of a communication apparatus according to an embodiment of this application.

### DESCRIPTION OF EMBODIMENTS

For ease of understanding, the following first describes technical terms in embodiments of this application.

### 1. Beam

The beam is a special directional sending or receiving effect formed by a transmitter or a receiver of a network device or a terminal by using an array antenna, and is similar to a light beam formed by converging light to a direction by using a flashlight. Signal sending and receiving in a form of the beam can effectively increase a signal transmission distance.

The beam may be a wide beam, a narrow beam, or another type of beam. A technology for forming the beam may be a beamforming technology or another technology. The beamforming technology may be a digital beamforming technology, an analog beamforming technology, a hybrid digital/analog beamforming technology, or the like.

The beam generally corresponds to a resource. For example, during beam measurement, the network device measures different beams by using different resources, and the terminal feeds back measured resource quality, so that the network device can know quality of a corresponding beam. During data transmission, the beam may be indicated by using a resource corresponding to the beam. For example, the network device indicates a transmission configuration indicator-state by using a transmission configuration indicator (TCI) field in downlink control information (DCI), and the terminal determines, based on a reference resource included in the TCI-state, a beam corresponding to the reference resource.

In a communication protocol, the beam may be represented as a digital beam, an analog beam, a spatial domain filter, a spatial filter, a spatial parameter, a TCI, a TCI-state, or the like. A beam used to send a signal may be referred to as a transmitted beam (or Tx beam), a spatial domain transmitted filter, a spatial transmitted filter, a spatial domain transmitted parameter, a spatial transmitted parameter, or the like. A beam used to receive a signal may be referred to as a received beam (or Rx beam), a spatial domain received filter, a spatial received filter, a spatial domain received parameter, a spatial received parameter, or the like.

It may be understood that the beam in embodiments of this application may be replaced with and understood as another equivalent concept, and is not limited to the foregoing mentioned concepts.

### 2. Array Antenna

To make the array antenna better meet expectations of people, a designer usually expects that a signal can be received normally while being sent normally, to meet requirements such as high performance, a low sidelobe, and easy beamforming of the array antenna. On this basis, an array element of the array antenna, as an important part of the array antenna, plays an important role in implementing the foregoing characteristics. Currently, there are mainly two types of array element structures of the array antenna: a structure in which array element spacings are the same, where an antenna having this array element structure is also referred to as a uniform array antenna; and a structure in which array element spacings are different, where an antenna having this array element structure is also referred to as a non-uniform array antenna.

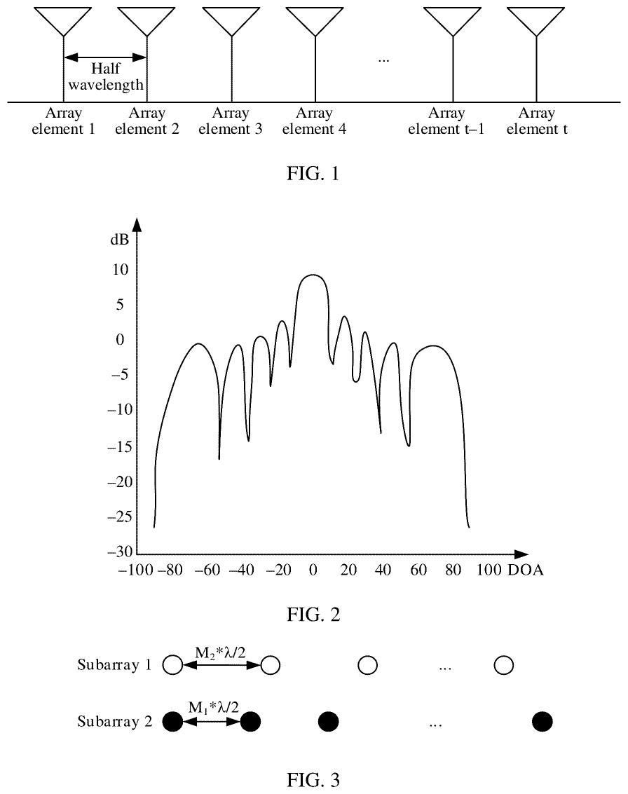

The uniform array antenna may be a uniform linear array antenna, a uniform circular array antenna, or a uniform rectangular array antenna. The uniform linear array antenna is used as an example. As shown in FIG. 1, array element spacings (half wavelengths), incentives, and phases in the uniform linear array antenna may be the same. The uniform linear array antenna may form a low-sidelobe effect through a weighted design in a vertical direction, to resolve a problem of a radar false alarm. When a signal-to-noise ratio is high, the uniform linear array antenna can be used to estimate an angle for receiving a beam, in other words, estimate a direction of arrival (DOA), or position a beam direction. A degree of freedom that can be used by the uniform linear array antenna for spatial spectrum estimation, for example, a maximum quantity of DOAs that can be estimated, or a quantity of received beams, is a quantity of array elements of the uniform linear array antenna minus 1. In addition, a transmitted beam of the uniform linear array antenna corresponds to the received beam of the uniform linear array antenna, and a quantity of transmitted beams is also the quantity of array elements minus 1.

For example, as shown in FIG. 2, a horizontal coordinate corresponding to a wave crest position in FIG. 2 is an estimated DOA. It can be seen that when the quantity of array elements of the uniform linear array antenna is 10, a maximum of nine DOAs can be estimated. In addition, as shown in FIG. 2, a sidelobe suppression effect of the uniform linear array antenna is not clear when there is no noise. Therefore, to obtain a DOA with higher resolution, that is, an angle of a beam, a used algorithm has a very large computation amount, to implement estimation with higher precision. The algorithm for estimating the DOA may include multiple signal classification (MUSIC), estimation of signal parameters via rotational invariance techniques (ESPRIT), a minimum variance distortionless response (MVDR), and the like. This is not limited.

It may be understood that the uniform linear array antenna is usually applicable to one-dimensional DOA estimation, and the uniform circular array antenna or the uniform rectangular array antenna may be applicable to two-dimensional DOA estimation, to implement application in a scenario of higher precision.

In comparison with the uniform array antenna, the non-uniform array antenna has a higher degree of freedom of spatial spectrum estimation, and can be used to estimate more DOAs. A typical non-uniform array antenna is a coprime array antenna. As shown in FIG. 3, the coprime array antenna includes two subarrays with different spacings: one subarray includes M₁ array elements, and is denoted as a subarray 1; and the other subarray includes M₂ array elements, and is denoted as a subarray 2. M₁ and M₂ are prime numbers of each other. Half wavelengths of the array elements in the subarray 1 and the subarray 2 are the same. On this basis, a spacing between any two adjacent array elements in the subarray 1 is M₂ times the half wavelength, and a spacing between any two adjacent array elements in the subarray 2 is M₁ times the half wavelength. During actual disposition, the subarray 1 and the subarray 2 may be disposed together with one end aligned, to form a non-uniform linear array antenna. In this case, the subarray 1 and the subarray 2 may share one array element at an overlapping end point position, and array elements at other positions do not overlap each other. In other words, the non-uniform linear array antenna actually includes M₁+M₂−1 array elements.

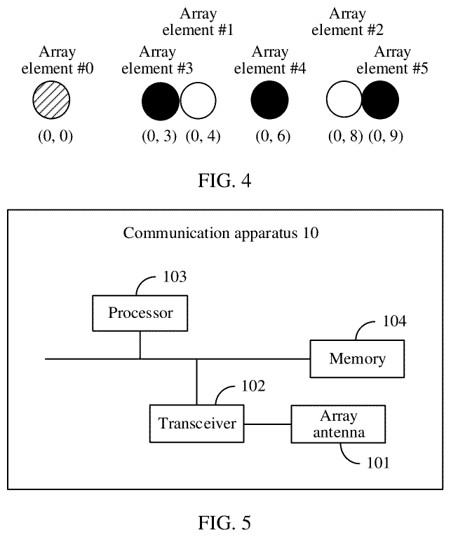

For example, as shown in FIG. 4, M₁=3, and M₂=4. The subarray 1 includes an array element #0, an array element #1, and an array element #2, the subarray 2 includes the array element #0, an array element #3, an array element #4, and an array element #5, and there are six array elements in total. In this case, the half wavelength is denoted as 1, the array element #0 is disposed at a position whose coordinates are (0, 0), the array element #1 is disposed at a position whose coordinates are (0, 4), the array element #2 is disposed at a position whose coordinates are (0, 8), the array element #3 is disposed at a position whose coordinates are (0, 3), the array element #4 is disposed at a position whose coordinates are (0, 6), and the array element #5 is disposed at a position whose coordinates are (0, 9). When a vertical coordinate is omitted, positions of the array element #0 to the array element #5 may be represented as follows: The array element #0 is disposed at 0, the array element #1 is disposed at 4, the array element #2 is disposed at 8, the array element #3 is disposed at 3, the array element #4 is disposed at 6, and the array element #5 is disposed at 9.

It can be seen that because values of the prime numbers are usually greater than 1, and are, for example, 2 and 3, or 3 and 5, the coprime array antenna has a larger array element spacing, and has an array structure feature of sparse array deployment, so that the coprime array antenna can be equivalent to a uniform linear array antenna with more array elements but a smaller array element spacing. Therefore, a quantity of estimated DOAs can increase, and better performance of the array antenna can be implemented.

For example, the coprime array antenna includes L array elements, and positions of the array elements are respectively n_{S}=[n₁, n₂, . . . , n_{L}]*d, where d=λ/2, and λ is a wavelength. A receive channel model of the coprime array antenna may be expressed as x(t)=As(t)+n(t). A may be an array manifold matrix, and may be expressed as A=[a(θ₁), . . . , a(θ_{K})]. a(θₖ)=[e^{jπn}^{₁}^{sin(θ}^{ₖ}⁾, . . . , e^{jπn}^{_{L}}^{sin(θ}^{ₖ}⁾]^{T}, where θₖ may be an angle of a k^{th} received beam, n(t) may be channel noise, and may be expressed as σₙ² and a superscript T represents a transposition. On this basis, a covariance matrix of x(t) may be expressed as Rₓₓ=E[x·x^{H}]=AR_{SS}A^{H}+σ²I_{L}, where E[ ] represents a covariance operation, x(t) may be denoted as x, a superscript H represents a conjugate transposition, R_{SS}, is a diagonal matrix, a diagonal element may be an unknown, for example, σ1², . . . , σ_{K}², and I_{L} is a unit matrix of L*L. In this case, a vectorized representation of Rₓₓ may be obtained by vectorizing Rₓₓ, and may be represented as z₁=vec(Rₓₓ)=(A*⊙A)hᵢ+σₙ²vec(I_{L}), where z₁ is a vector of one being multiplied by a plurality of dimensions, a superscript * represents a conjugate, ⊙ is a Khatri-Rao (Khatri-Rao) product, h₁=[σₙ², . . . , σ_{K}²]^{T} is a vectorized representation of noise, and vec(⊙) represents vectorization.

It may be understood that after vectorized representation may be performed on the receive channel model of the coprime array antenna, the vectorized representation and an array structure of the uniform linear array antenna are similar, and both are a structure of one being multiplied by a plurality of dimensions. Therefore, the coprime array antenna may alternatively be equivalent to the uniform linear array antenna, and positions of array elements of the uniform linear array antenna may be expressed as ViArray=(nₐ−n_{b})*d, where 1≤a, and b≤L. In other words, the positions of the array elements of the equivalent uniform linear array antenna may be obtained based on differentials between the positions of the array elements of the coprime array antenna.

The coprime array antenna shown in FIG. 4 is still used as an example. The positions of the array elements of the equivalent uniform linear array antenna may be represented as 0, ±1(9-8), ±2(6-4), ±3(9-6), ±4(8-4), ±5(9-4), and ±6(9-3). There are 13 positions in total, in other words, it indicates that the equivalent uniform linear array antenna may include 13 array elements. In other words, a quantity of DOAs that can be estimated by using the coprime array antenna is 12, where the quantity is larger than a quantity of DOAs estimated by using an equivalent uniform array antenna with a same quantity of array elements. In other words, when a same quantity of DOAs are estimated, a quantity of array elements of the coprime array antenna is smaller, an algorithm used for DOA estimation also has a smaller computation amount, and computation efficiency is higher.

However, with development of technologies, future communication may have a higher requirement on performance of the array antenna, and need a higher degree of freedom of spectrum estimation, in other words, need to establish a large quantity of DOAs. A current coprime array antenna cannot meet this requirement.

For the foregoing technical problem, embodiments of this application provide the following technical solutions, to estimate a large quantity of DOAs.

The following describes technical solutions of this application with reference to accompanying drawings.

The technical solutions in embodiments of this application may be applied to various communication systems, for example, a wireless network (Wi-Fi) system, a vehicle-to-everything (V2X) communication system, a device-to-device (D2D) communication system, an internet-of-vehicles communication system, a 4th generation (4G) mobile communication system, for example, a long term evolution (LTE) system, and a worldwide interoperability for microwave access (WiMAX) communication system, 5th generation (5G), for example, a new radio (NR) system, and a future communication system.

All aspects, embodiments, or features are presented in this application by describing a system that may include a plurality of devices, components, modules, and the like. It should be appreciated and understood that each system may include another device, component, module, and the like, and/or may not include all devices, components, modules, and the like discussed with reference to the accompanying drawings. In addition, a combination of these solutions may be used.

In addition, in embodiments of this application, the word like “example” or “for example” indicates giving an example, an illustration, or a description. Any embodiment or design solution described as an “example” in this application should not be explained as being more preferred or having more advantages than another embodiment or design solution. Exactly, use of the word “example” is intended to present a concept in a specific manner.

In embodiments of this application, “information”, “signal”, “message”, “channel”, and “signaling” may be interchangeably used sometimes. It should be noted that meanings expressed by the terms are matchable when differences of the terms are not emphasized. “Of”, “corresponding (or relevant)”, and “corresponding” may sometimes be interchangeably used. It should be noted that meanings expressed by the terms are matchable when differences of the terms are not emphasized. In addition, “/” mentioned in this application may indicate an “or” relationship.

The network architecture and the service scenario described in embodiments of this application are intended to describe the technical solutions in embodiments of this application more clearly, and do not constitute a limitation on the technical solutions provided in embodiments of this application. A person of ordinary skill in the art may know that with evolution of the network architecture and emergence of a new service scenario, the technical solutions provided in embodiments of this application are also applicable to a similar technical problem.

An embodiment of this application provides a communication apparatus. The communication apparatus may be applicable to a communication system, and may be a terminal or a network device.

The terminal is a terminal that accesses a network and that has a wireless transceiver function, or a chip or a chip system that can be disposed in the terminal. The terminal may also be referred to as user equipment (UE), an access terminal, a subscriber unit, a subscriber station, a mobile station (MS), a remote station, a remote terminal, a mobile device, a user terminal, a terminal, a wireless communication device, a user agent, or a user apparatus. The terminal in this embodiment of this application may be a mobile phone, a cellular phone, a smartphone, a tablet computer, a wireless data card, a personal digital assistant (PDA) computer, a wireless modem, a handset, a laptop computer, a machine type communication (MTC) terminal, a computer having a wireless transceiver function, a virtual reality (VR) terminal, an augmented reality terminal, a wireless terminal in industrial control, a wireless terminal in self-driving, a wireless terminal in telemedicine, a wireless terminal in a smart grid, a wireless terminal in transportation safety, a wireless terminal in a smart city, a wireless terminal in a smart home, a vehicle-mounted terminal, an RSU that has a terminal function, or the like. The terminal in this application may alternatively be a vehicle-mounted module, a vehicle-mounted assembly, a vehicle-mounted part, a vehicle-mounted chip, or a vehicle-mounted unit that is built in a vehicle as one or more parts or units.

The network device, for example, an access network device, is a device that is located on a network side of the communication system and that has a wireless transceiver function, or a chip or a chip system that can be disposed in the device. The network device may include a next-generation mobile communication system, for example, a 6G access network device, for example, a 6G base station or a 6G core network element. Alternatively, in a next-generation mobile communication system, the network device may be named in another manner, which falls within the protection scope of embodiments of this application. This is not limited in this application. In addition, the network device may alternatively include a gNB in 5G such as an NR system, or one antenna panel or a group of antenna panels (including a plurality of antenna panels) of a base station in 5G; or may be a network node that forms a gNB, a transmission point (also called transmission reception point, TRP, or TP), or a transmission measurement function (TMF), for example, a baseband unit (BBU), a CU, a DU, a road side unit (RSU) having abase station function, or a wired access gateway. In addition, the network device may alternatively include an access point (AP) in a wireless fidelity (Wi-Fi) system, a wireless relay node, a wireless backhaul node, macro base stations in various forms, a micro base station (also referred to as a small cell), a relay station, an access point, a wearable device, a vehicle-mounted device, or the like.

FIG. 5 is a diagram 1 of a structure of a communication apparatus according to an embodiment of this application. As shown in FIG. 5, the communication apparatus 10 may include an array antenna 101, and optionally, may further include a transceiver 102 connected to the array antenna 101, a processor 103 connected to the transceiver 102, and a memory 104 connected to the processor 103.

The array antenna 101 is mainly configured to implement a signal transceiver function of the communication apparatus 10. There may be one or more array antennas 101. For example, a plurality of array antennas 101 may be disposed in a same direction or different directions to form an antenna panel. In addition, for a structure of the array antenna 101, refer to the following related descriptions. Details are not described herein.

The transceiver 102 is mainly configured to drive the array antenna 101, to implement the signal transceiver function. The transceiver 102 may be a transceiver circuit, an interface circuit, or any other possible circuit or element. This is not limited herein. In addition, the transceiver 102 and the array antenna 101 may alternatively form a chip of the communication apparatus 10, for example, a radio frequency chip, a processing chip, or any other possible chip. In other words, it may be considered that the chip includes the transceiver 102 and the array antenna 101.

The processor 103 is a control center of the communication apparatus 10, and may be a processing element, or may be a general name of a plurality of processing elements, or may also be referred to as a logic circuit. For example, the processor 103 is one or more central processing units (CPUs), or may be an application-specific integrated circuit (ASIC), or is configured as one or more integrated circuits for implementing embodiments of this application, for example, one or more digital signal processors (DSPs) or one or more field programmable gate arrays (FPGAs). The processor 103 may perform various functions of the communication apparatus 10 by running or executing a software program stored in the memory 104 and invoking data stored in the memory 104, for example, controlling the transceiver 102 to drive the array antenna 101 to transmit a signal or controlling the transceiver 102 to drive the array antenna 101 to receive a signal. During implementation, the processor 103 may include one or more CPUs. The communication apparatus 10 may alternatively include a plurality of processors 103. Each of the processors 103 may be a single-core processor (single-CPU), or may be a multi-core processor (multi-CPU). The processor 103 herein may be one or more devices, circuits, and/or processing cores configured to process data (for example, computer program instructions).

The memory 104 is configured to store the software program for executing the solutions of this application, and the processor 103 controls the execution, so that the communication apparatus 10 can complete the foregoing functions. Optionally, the memory 104 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another compact disc storage, an optical disk storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. However, this is not limited thereto.

FIG. 6 is a diagram 2 of a structure of a communication apparatus according to an embodiment of this application. As shown in FIG. 6, the communication apparatus 10 further includes a body. The body may include a middle frame 105 and a backplane 106. The foregoing one or more array antennas 101 may be disposed on the backplane 106. The foregoing transceiver 102, processor 103, and memory 104 may be disposed in the body (not shown in FIG. 6).

The following describes an array antenna in embodiments of this application.

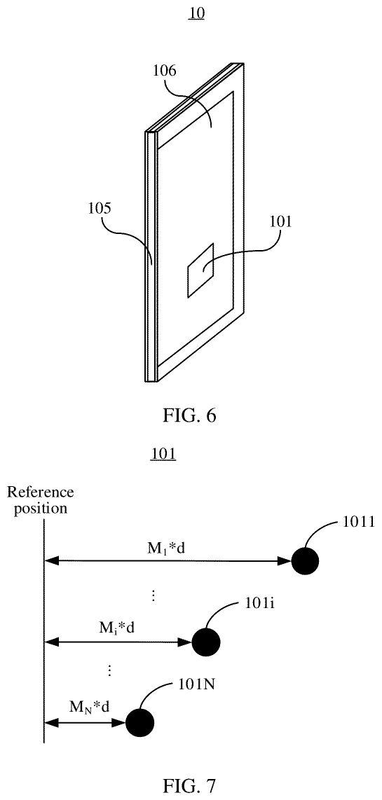

FIG. 7 is a diagram 1 of a structure of an array antenna according to an embodiment of this application. As shown in FIG. 7, the array antenna 101 includes N array elements (1011 to 101N) disposed in a same direction (denoted as a direction 1), and N is an integer greater than or equal to 3.

A spacing between an i^{th} array element 101i in the N array elements (1011 to 101N) and a reference position in the direction 1 is Mᵢ times a unit length, and i is any integer from 1 to N. Half wavelengths of the N array elements (1011 to 101N) are the same, and the unit length is a positive integer multiple of the half wavelength (denoted as d). The N array elements (1011 to 101N) are in one-to-one correspondence with N positive integers (J₁ to J_{N}), and any two of the N positive integers are prime numbers of each other. In this case, Mᵢ may be a product of N−1 positive integers, and the N−1 positive integers are integers other than a positive integer corresponding to the i^{th} array element 101 in the N positive integers.

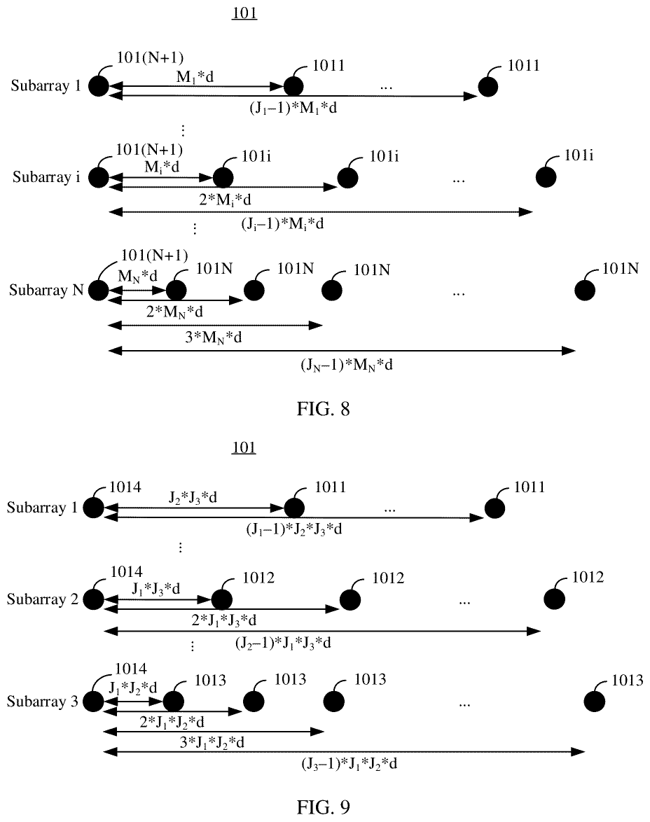

It may be understood that the positive integer multiple between the unit length and the half wavelength may change, for example, may be one time, two times, or three times. This is not limited. In this case, it may also be understood as that the spacing between the i^{th} array element 101 and the reference position may proportionally change. In other words, the i^{th} array element 101 may be disposed at different positions in a proportionally changing manner, that is, there may be a plurality of i^{th} array elements 101i. For example, a quantity of i^{th} array elements 101i may be a positive integer J₁ corresponding to the i^{th} array element 101 minus 1. In this case, the plurality of array elements 101 may also be considered as an i^{th} subarray. In this case, as shown in FIG. 8, the array antenna may include N subarrays, and the N subarrays each have a different spacing between two adjacent array elements, so that the N subarrays can be disposed together in an embedded manner to form an N-dimensional coprime linear subarray. Optionally, as shown in FIG. 8, the array antenna 101 further includes an array element 101(N+1), namely, an (N+1)^{th} array element 101(N+1), disposed at the reference position. The array element 101(N+1) may be shared by the N subarrays, or belongs to all of the N subarrays.

On this basis, an example in which coordinates of the reference position are (0, 0) is used. Coordinates L_{S} of all the array elements of the array antenna 101 may be expressed as the following formulas 1 to 4:

$${L}_{s} = \{ ( 0 , {M}_{1} * d ) ⋃ ( 0 , {M}_{2} * d ) … ( 0 , {M}_{a} * d ) \} ; \qquad ( 1 )$$

$${M}_{1} = 0 , 1 * {J}_{2} * {J}_{3} * … * {J}_{a} , … , ( {J}_{1} - 1 ) * {J}_{2} * {J}_{3} * … * {J}_{a} ; \qquad ( 2 )$$

$${M}_{2} = 0 , 1 * {J}_{1} * {J}_{3} * … * {J}_{a} , … , ( {J}_{2} - 1 ) * {J}_{1} * {J}_{3} * … * {J}_{a} ; and \qquad ( 3 )$$

$${M}_{a} = 0 , 1 * {J}_{1} * {J}_{2} * {J}_{3} * … * {J}_{a - 1} , … , ( {J}_{a} - 1 ) * {J}_{1} * {J}_{2} * {J}_{3} * … * {J}_{a - 1} . \qquad ( 4 )$$

For ease of understanding, as shown in FIG. 9, an example in which the N array elements (1011 to 101N) include a first array element 1011, a second array element 1012, and a third array element 1013 is used. Optionally, the array element 101(N+1) further includes a fourth array element 1014.

A spacing between the first array element 1011 and the reference position is M₁ times the unit length, and a positive integer corresponding to the first array element 1011 is J₁. In this case, a quantity of first array elements 1011 may be J₁-1, in other words, the (J₁-1) first array elements 1011 may form a first subarray. A 1^{st} first array element 1011 may be disposed at a position at which a spacing between the 1^{st} first array element 1011 and the reference position is M₁ times the half wavelength, a 2^{nd} first array element 1011 may be disposed at a position at which a spacing between the 2^{nd} first array element 1011 and the reference position is 2*M₁ times the half wavelength, . . . , and a (J₁-1)^{th} first array element 1011 may be disposed at a position at which a spacing between the (J₁-1)^{th} first array element 1011 and the reference position is (J₁-1)*M₁ times the half wavelength.

A spacing between the second array element 1012 and the reference position is M₂ times the unit length, and a positive integer corresponding to the second array element 1012 is J₂. In this case, a quantity of second array elements 1012 may be J₂-1, in other words, the (J₂-1) second array elements 1012 may form a second subarray. A 1^{st} second array element 1012 may be disposed at a position at which a spacing between the 1^{st} second array element 1012 and the reference position is M₂ times the half wavelength, a 2^{nd} second array element 1012 may be disposed at a position at which a spacing between the 2^{nd} second array element 1012 and the reference position is 2*M₂ times the half wavelength, . . . , and a (J₂-1)^{th} second array element 1012 may be disposed at a position at which a spacing between the (J₂-1)^{th} second array element 1012 and the reference position is (J₂-1)*M₂ times the half wavelength.

A spacing between the third array element 1013 and the reference position is M₃ times the unit length, and a positive integer corresponding to the third array element 1013 is J₃. In this case, a quantity of third array elements 1013 may be J₃-1, in other words, the (J₃-1) third array elements 1013 may form a third subarray. A 1^{st} third array element 1013 may be disposed at a position at which a spacing between the 1^{st} third array element 1013 and the reference position is M₃ times the half wavelength, a 2^{nd} third array element 1013 may be disposed at a position at which a spacing between the 2^{nd} third array element 1013 and the reference position is 2*M₃ times the half wavelength, . . . , and a (J₃-1)^{th} third array element 1013 may be disposed at a position at which a spacing between the (J₃-1)^{th} third array element 1013 and the reference position is (J₃-1)*M₃ times the half wavelength.

Optionally, the fourth array element 1014 may be disposed at the reference position, and is shared by the first subarray, the second subarray, and the third subarray. In this case, the first subarray may include one fourth array element 1014 and the (J₁-1) first array elements 1011, the second subarray may include one fourth array element 1014 and the (J₂-1) second array elements 1012, and the third subarray may include one fourth array element 1014 and the (J₃-1) third array elements 1013.

It may be understood that M₁ is a product of J₂ and J₃, M₂ is a product of J₁ and J₃, M₃ is a product of J₁ and J₂, and any two integers in J₁, J₂, and J₃ are prime numbers of each other. In this case, when the first subarray, the second subarray, and the third subarray are embedded together to form a three-dimensional coprime linear array, positions of array elements of the three-dimensional coprime linear array may not overlap each other, so that performance of the array antenna can be improved, and more DOAs can be estimated.

For example, in some possible implementations, values of the N positive integers, for example, values of J₁, J₂, and J₃, may meet at least one combination of the following: J₁=2, J₂=3, and J₃=5 (denoted as Combination 1); J₁=2, J₂=3, and J₃=7 (denoted as Combination 2); J₁=2, J₂=3, and J₃=11 (denoted as Combination 3); J₁=2, J₂=5, and J₃=7 (denoted as Combination 4); J₁=3, J₂=4, and J₃=5 (denoted as Combination 5); or J₁=3, J₂=4, and J₃=7 (denoted as Combination 6), to form different forms of array antennas. The following separately provides descriptions.

### Combination 1

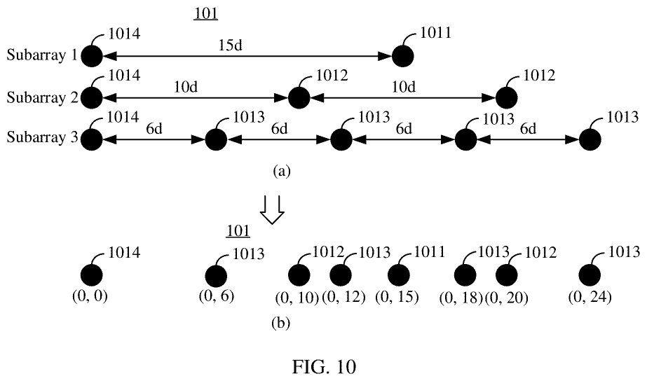

As shown in (a) in FIG. 10, the first subarray may include one fourth array element 1014 and one first array element 1011. The first array element 1011 is disposed at a position at which a spacing between the first array element 1011 and the reference position is 15 times the half wavelength. The second subarray may include one fourth array element 1014 and two second array elements 1012. A 1^{st} second array element 1012 is disposed at a position at which a spacing between the 1^{st} second array element 1012 and the reference position is 10 times the half wavelength, and a 2^{nd} second array element 1012 is disposed at a position at which a spacing between the 2^{nd} second array element 1012 and the reference position is 20 times the half wavelength. The third subarray may include one fourth array element 1014 and four third array elements 1013. A 1′ third array element 1013 is disposed at a position at which a spacing between the 1^{st} third array element 1013 and the reference position is six times the half wavelength, a 2^{nd} third array element 1013 is disposed at a position at which a spacing between the 2^{nd} third array element 1013 and the reference position is 12 times the half wavelength, a 3^{rd} third array element 1013 is disposed at a position at which a spacing between the 3^{rd} third array element 1013 and the reference position is 18 times the half wavelength, and a 4^{th} third array element 1013 is disposed at a position at which a spacing between the 4^{th} third array element 1013 and the reference position is 24 times the half wavelength.

As shown in (b) in FIG. 10, when the first subarray, the second subarray, and the third subarray are embedded together to form a three-dimensional coprime linear array, the first subarray, the second subarray, and the third subarray share a same fourth array element 1014, which is located at the reference position. The coordinates of the reference position may be denoted as (0, 0). On this basis, if the half wavelength is denoted as 1, coordinates of the first array element 1011 are (0, 15), coordinates of the 1^{st} second array element 1012 are (0, 10), coordinates of the 2^{nd} second array element 1012 are (0, 20), coordinates of the 1^{st} third array element 1013 are (0, 6), coordinates of the 2^{nd} third array element 1013 are (0, 12), coordinates of the 3^{rd} third array element 1013 are (0, 18), and coordinates of the 4^{th} third array element 1013 are (0, 24). It can be seen that for Combination 1, the array antenna 101 may include: 2+3+5−2=8 array elements in total, and positions of the eight array elements do not overlap each other.

### Combination 2

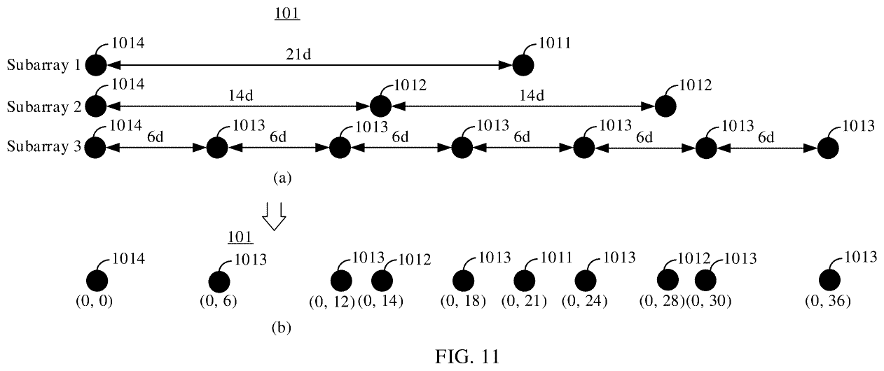

As shown in (a) in FIG. 11, the first subarray may include one fourth array element 1014 and one first array element 1011. The first array element 1011 is disposed at a position at which a spacing between the first array element 1011 and the reference position is 21 times the half wavelength. The second subarray may include one fourth array element 1014 and two second array elements 1012. A 1^{st} second array element 1012 is disposed at a position at which a spacing between the 1^{st} second array element 1012 and the reference position is 14 times the half wavelength, and a 2^{nd} second array element 1012 is disposed at a position at which a spacing between the 2^{nd} second array element 1012 and the reference position is 28 times the half wavelength. The third subarray may include one fourth array element 1014 and six third array elements 1013. A disposition manner of positions is similar to that of the third subarray shown in (a) in FIG. 10, and reference may be made for understanding. Details are not described again.

As shown in (b) in FIG. 11, when the first subarray, the second subarray, and the third subarray are embedded together to form a three-dimensional coprime linear array, similar to (b) in FIG. 10, coordinates of the fourth array element 1014 are (0, 0), coordinates of the first array element 1011 are (0, 21), coordinates of the 1^{st} second array element 1012 are (0, 14), coordinates of the 2^{nd} second array element 1012 are (0, 28), coordinates of a 1^{st} third array element 1013 are (0, 6), coordinates of a 2^{nd} third array element 1013 are (0, 12), . . . , and coordinates of a 6^{th} third array element 1013 are (0, 36). It can be seen that for Combination 2, the array antenna 101 may include: 2+3+7−2=10 array elements in total, and positions of the 10 array elements do not overlap each other.

### Combination 3

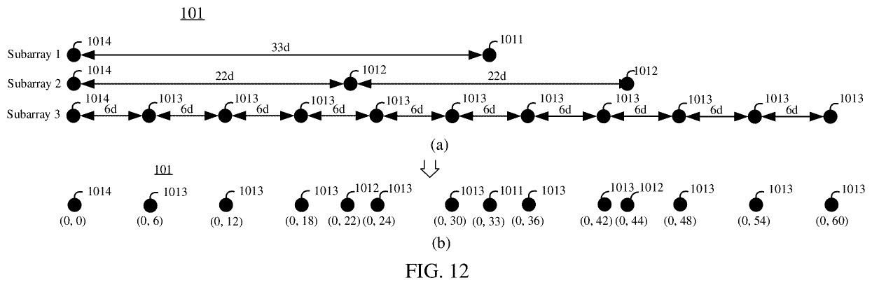

As shown in (a) in FIG. 12, the first subarray may include one fourth array element 1014 and one first array element 1011. The first array element 1011 is disposed at a position at which a spacing between the first array element 1011 and the reference position is 33 times the half wavelength. The second subarray may include one fourth array element 1014 and two second array elements 1012. A 1^{st} second array element 1012 is disposed at a position at which a spacing between the 1^{st} second array element 1012 and the reference position is 22 times the half wavelength, and a 2^{nd} second array element 1012 is disposed at a position at which a spacing between the 2^{nd} second array element 1012 and the reference position is 44 times the half wavelength. The third subarray may include one fourth array element 1014 and 10 third array elements 1013. A disposition manner of positions is similar to that of the third subarray shown in (a) in FIG. 10, and reference may be made for understanding. Details are not described again.

As shown in (b) in FIG. 12, when the first subarray, the second subarray, and the third subarray are embedded together to form a three-dimensional coprime linear array, similar to (b) in FIG. 10, coordinates of the fourth array element 1014 are (0, 0), coordinates of the first array element 1011 are (0, 33), coordinates of the 1^{st} second array element 1012 are (0, 22), coordinates of the 2^{nd} second array element 1012 are (0, 44), coordinates of a 1^{st} third array element 1013 are (0, 6), coordinates of a 2^{nd} third array element 1013 are (0, 12), . . . , and coordinates of a 10^{th} third array element 1013 are (0, 60). It can be seen that for Combination 3, the array antenna 101 may include: 2+3+11−2=14 array elements in total, and positions of the 14 array elements do not overlap each other.

### Combination 4

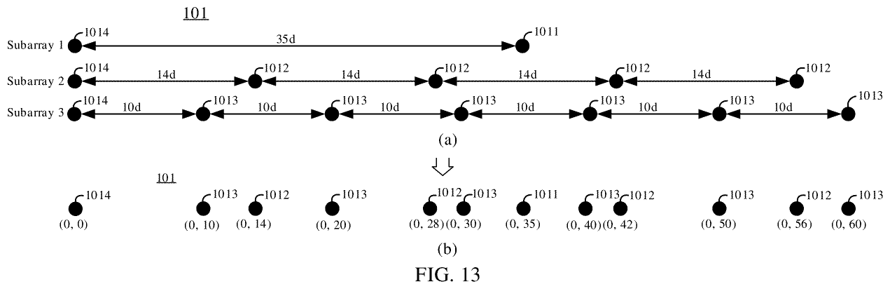

As shown in (a) in FIG. 13, the first subarray may include one fourth array element 1014 and one first array element 1011. The first array element 1011 is disposed at a position at which a spacing between the first array element 1011 and the reference position is 35 times the half wavelength. The second subarray may include one fourth array element 1014 and four second array elements 1012. A 1^{st} second array element 1012 is disposed at a position at which a spacing between the 1^{st} second array element 1012 and the reference position is 14 times the half wavelength, a 2^{nd} second array element 1012 is disposed at a position at which a spacing between the 2^{nd} second array element 1012 and the reference position is 28 times the half wavelength, a 3^{rd} second array element 1012 is disposed at a position at which a spacing between the 3^{rd} second array element 1012 and the reference position is 42 times the half wavelength, and a 4^{th} second array element 1012 is disposed at a position at which a spacing between the 4^{th} second array element 1012 and the reference position is 56 times the half wavelength. The third subarray may include one fourth array element 1014 and six third array elements 1013. A 1^{st} third array element 1013 is disposed at a position at which a spacing between the 1^{st} third array element 1013 and the reference position is 10 times the half wavelength, a 2^{nd} third array element 1013 is disposed at a position at which a spacing between the 2^{nd} third array element 1013 and the reference position is 20 times the half wavelength, . . . , and a 6^{th} third array element 1013 is disposed at a position at which a spacing between the 6^{th} third array element 1013 and the reference position is 60 times the half wavelength.

As shown in (b) in FIG. 13, when the first subarray, the second subarray, and the third subarray are embedded together to form a three-dimensional coprime linear array, similar to (b) in FIG. 10, coordinates of the fourth array element 1014 are (0, 0), coordinates of the first array element 1011 are (0, 35), coordinates of the 1^{st} second array element 1012 are (0, 14), coordinates of the 2^{nd} second array element 1012 are (0, 28), coordinates of the 3^{rd} second array element 1012 are (0, 42), . . . , coordinates of the 4^{th} second array element 1012 are (0, 56), coordinates of the 1^{st} third array element 1013 are (0, 10), coordinates of the 2^{nd} third array element 1013 are (0, 20), . . . , and coordinates of the 6^{th} third array element 1013 are (0, 60). It can be seen that for Combination 4, the array antenna 101 may include: 2+5+7−2=12 array elements in total, and positions of the 12 array elements do not overlap each other.

### Combination 5

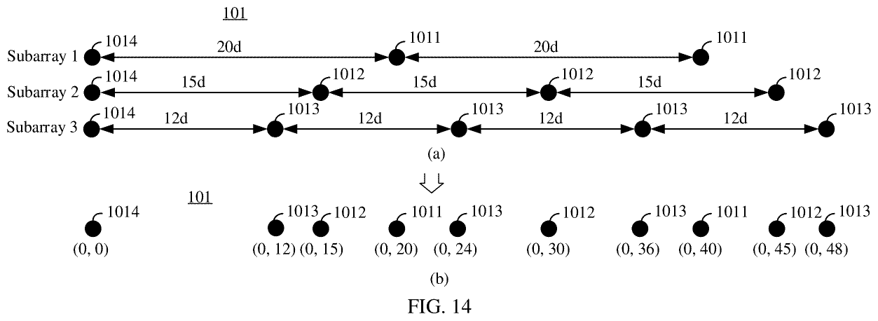

As shown in (a) in FIG. 14, the first subarray may include one fourth array element 1014 and two first array elements 1011. A 1^{st} first array element 1011 is disposed at a position at which a spacing between the 1^{st} first array element 1011 and the reference position is 20 times the half wavelength, and a 2^{nd} first array element 1011 is disposed at a position at which a spacing between the 2^{nd} first array element 1011 and the reference position is 40 times the half wavelength. The second subarray may include one fourth array element 1014 and three second array elements 1012. A 1^{st} second array element 1012 is disposed at a position at which a spacing between the 1^{st} second array element 1012 and the reference position is 15 times the half wavelength, a 2^{nd} second array element 1012 is disposed at a position at which a spacing between the 2^{nd} second array element 1012 and the reference position is 30 times the half wavelength, and a 3^{rd} second array element 1012 is disposed at a position at which a spacing between the 3^{rd} second array element 1012 and the reference position is 45 times the half wavelength. The third subarray may include one fourth array element 1014 and four third array elements 1013. A 1′ third array element 1013 is disposed at a position at which a spacing between the 1^{st} third array element 1013 and the reference position is 12 times the half wavelength, a 2^{nd} third array element 1013 is disposed at a position at which a spacing between the 2^{nd} third array element 1013 and the reference position is 24 times the half wavelength, . . . , and a 4^{th} third array element 1013 is disposed at a position at which a spacing between the 4^{th} third array element 1013 and the reference position is 48 times the half wavelength.

As shown in (b) in FIG. 14, when the first subarray, the second subarray, and the third subarray are embedded together to form a three-dimensional coprime linear array, similar to (b) in FIG. 10, coordinates of the fourth array element 1014 are (0, 0), coordinates of the 1^{st} first array element 1011 are (0, 20), coordinates of the 2^{nd} first array element 1011 are (0, 40), coordinates of the 1^{st} second array element 1012 are (0, 15), coordinates of the 2^{nd} second array element 1012 are (0, 30), coordinates of the 3^{rd} second array element 1012 are (0, 45), coordinates of the 1^{st} third array element 1013 are (0, 12), coordinates of the 2^{nd} third array element 1013 are (0, 24), . . . , and coordinates of the 4^{th} third array element 1013 are (0, 48). It can be seen that for Combination 5, the array antenna 101 may include: 3+4+5−2=10 array elements in total, and positions of the 10 array elements do not overlap each other.

### Combination 6

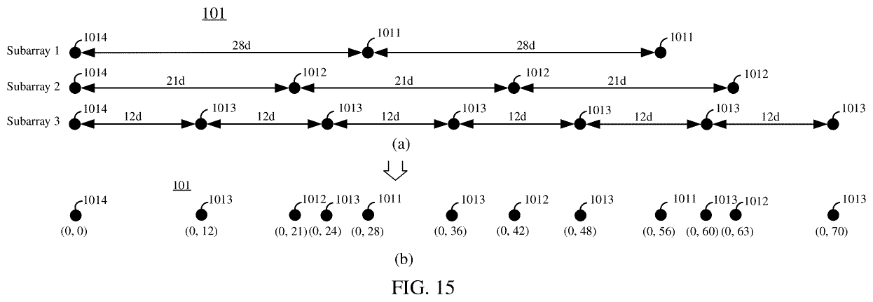

As shown in (a) in FIG. 15, the first subarray may include one fourth array element 1014 and two first array elements 1011. A 1^{st} first array element 1011 is disposed at a position at which a spacing between the 1^{st} first array element 1011 and the reference position is 28 times the half wavelength, and a 2^{nd} first array element 1011 is disposed at a position at which a spacing between the 2^{nd} first array element 1011 and the reference position is 56 times the half wavelength. The second subarray may include one fourth array element 1014 and three second array elements 1012. A 1^{st} second array element 1012 is disposed at a position at which a spacing between the 1^{st} second array element 1012 and the reference position is 21 times the half wavelength, a 2^{nd} second array element 1012 is disposed at a position at which a spacing between the 2^{nd} second array element 1012 and the reference position is 42 times the half wavelength, and a 3^{rd} second array element 1012 is disposed at a position at which a spacing between the 3^{rd} second array element 1012 and the reference position is 63 times the half wavelength. The third subarray may include one fourth array element 1014 and six third array elements 1013. A disposition manner of positions is similar to that of the third subarray shown in (a) in FIG. 14, and reference may be made for understanding. Details are not described again.

As shown in (b) in FIG. 15, when the first subarray, the second subarray, and the third subarray are embedded together to form a three-dimensional coprime linear array, similar to (b) in FIG. 10, coordinates of the fourth array element 1014 are (0, 0), coordinates of the 1^{st} first array element 1011 are (0, 28), coordinates of the 2^{nd} first array element 1011 are (0, 56), coordinates of the 1^{st} second array element 1012 are (0, 21), coordinates of the 2^{nd} second array element 1012 are (0, 42), coordinates of the 3^{rd} second array element 1012 are (0, 63), coordinates of a 1V third array element 1013 are (0, 12), coordinates of a 2^{nd} third array element 1013 are (0, 24), . . . , and coordinates of a 6^{th} third array element 1013 are (0, 70). It can be seen that for Combination 6, the array antenna 101 may include: 3+4+7−2=12 array elements in total, and positions of the 12 array elements do not overlap each other.

In this embodiment of this application, a product of the N positive integers may be positively correlated with a quantity of beams of the array antenna 101, and the quantity of beams of the array antenna 101 may be a quantity of beams transmitted or received by the array antenna. For example, the product of the N positive integers may be positively correlated with a quantity of array elements of a linear array equivalent to the array antenna 101, and the quantity of array elements of the linear array may be positively correlated with the quantity of beams of the array antenna 101.

For the N subarrays of the array antenna 101, coordinate positions of all array elements in every two subarrays may be subtracted from each other, that is, a first-order differential is performed, to obtain an equivalent linear array, for example, a non-uniform linear array antenna. A differential, in particular, a second-order differential, may continue to be performed on the non-uniform linear array. The rest may be deduced by analogy. A final equivalent linear array, for example, a uniform linear array antenna, may be obtained by performing an (N−1)-order differential. In this case, a quantity of array elements of the linear array is two times the product of the N positive integers plus 1. In other words, because an array element spacing of the array antenna 101 is large, for example, the spacing is usually a multiple of the half wavelength, the array antenna 101 may be equivalent to a uniform linear array antenna with more array elements and a smaller array element spacing, for example, a spacing of one half wavelength. In this case, a quantity of beams of the uniform linear array antenna is the quantity of beams of the array antenna 101. For example, the quantity of beams is two times the product of the N positive integers.

For ease of understanding, J₁, J₂, and J₃ are used as an example. A product of J₁, J₂, and J₃ is positively correlated with the quantity of beams of the array antenna, and the quantity of beams of the array antenna is the quantity of beams transmitted or received by the array antenna. For example, the product of J₁, J₂, and J₃ is positively correlated with the quantity of array elements of the linear array equivalent to the array antenna, and the quantity of array elements of the linear array is positively correlated with the quantity of beams of the array antenna. The quantity of array elements of the linear array is K, and that the product of J₁, J₂, and J₃ is positively correlated with the quantity of array elements of the linear array means that K=2*J₁*J₂*J₃+1. On this basis, that the quantity of array elements of the linear array is positively correlated with the quantity of beams of the array antenna means that the quantity of beams of the array antenna is K-1, that is, 2*J₁*J₂*J₃.

It can be seen that values of J₁, J₂, and J₃ may usually determine a quantity of array elements of the array antenna. For example, the quantity of array elements of the array antenna is J₁+J₂+J₃-2. In other words, only several array elements, for example, J₃ array elements, are added, so that the quantity of array elements of the equivalent linear array can exponentially increase, for example, increase by nearly J₃ times. In this way, the quantity of beams of the array antenna can also increase exponentially, so that a quantity of estimated DOAs significantly increases.

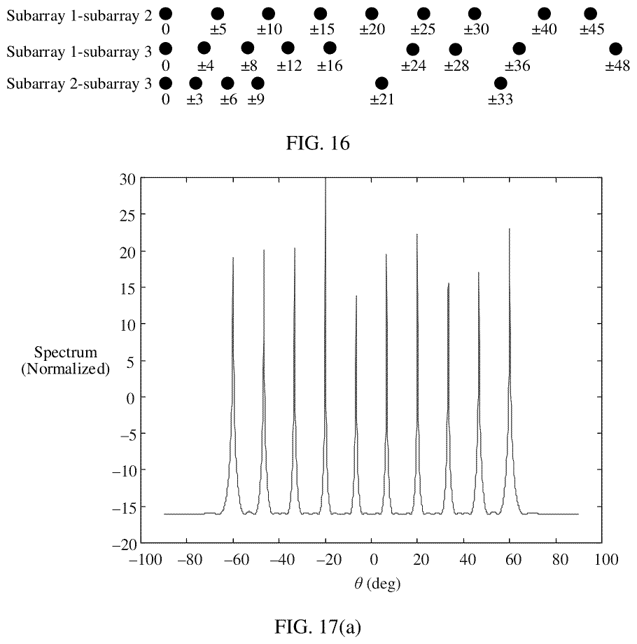

Combination 5 is used as an example. As shown in FIG. 16, a non-uniform linear array antenna whose quantity of array elements is 22 may be obtained by performing a first-order differential, subtracting coordinates of every two array elements in the array antenna corresponding to Combination 5 from each other. In this case, if the half wavelength is denoted as 1, coordinates of the array elements of the non-uniform linear array antenna are respectively (0, 0), (0, ±3), (0, ±4), (0, ±5), (0, ±6), (0, ±8), (0, ±9), (0, ±10), (0, ±12), (0, ±15), (0, ±16), (0, ±20), (0, ±21), (0, ±24), (0, ±25), (0, ±28), (0, ±30), (0, ±33), (0, ±36), (0, ±40), (0, ±45), and (0, ±48). A uniform linear array antenna whose quantity of array elements is 121 may be obtained by performing a second-order differential, subtracting coordinates of every two array elements in the non-uniform linear array antenna from each other. In this case, if the half wavelength is still denoted as 1, coordinates of the array elements of the uniform linear array antenna are respectively (0, −60, . . . , +60). In other words, in comparison with a two-dimensional coprime linear array antenna with six array elements in a conventional technology, in the array antenna 101 in this embodiment of this application, only five array elements are added, so that the quantity of beams can increase from 13 to 120, and a maximum of 120 DOAs can be estimated.

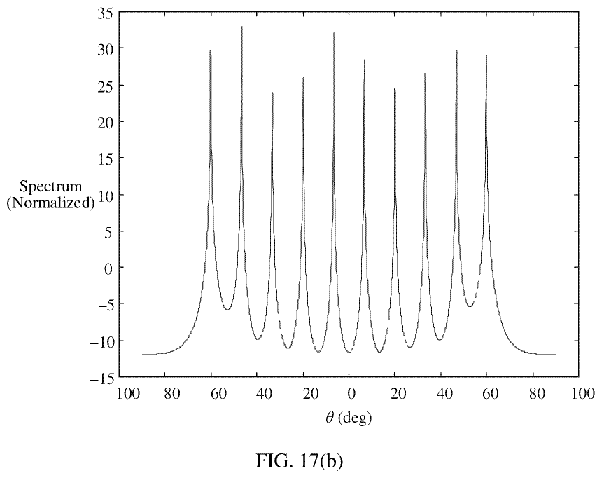

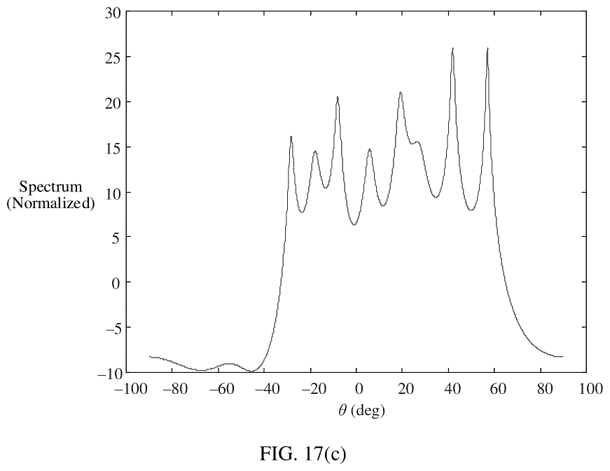

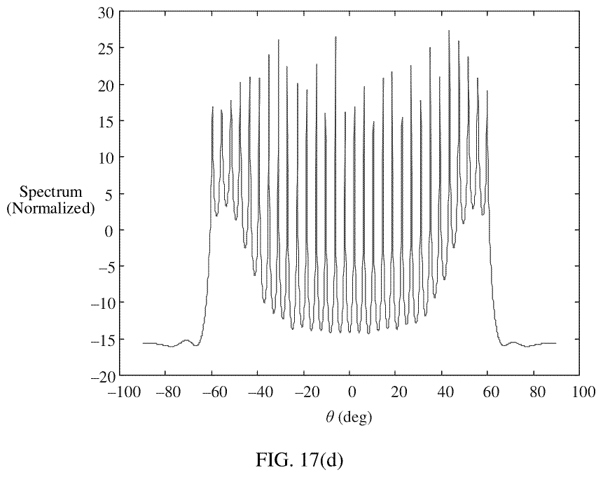

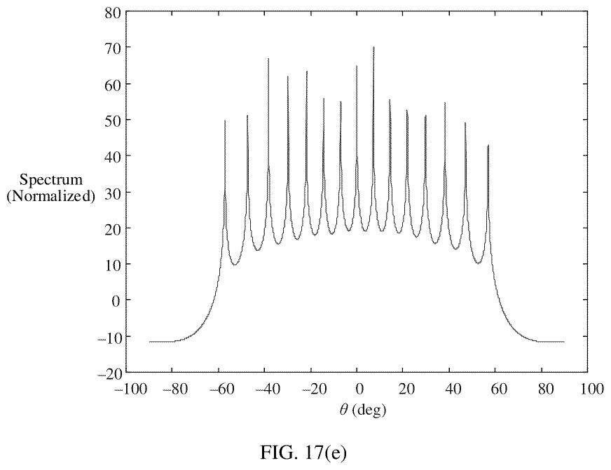

FIG. 17(a), FIG. 17(b), FIG. 17(c), FIG. 17(d), and FIG. 17(e) are a diagram 1 of simulation of DOA estimation. As shown in FIG. 17(a), FIG. 17(b), FIG. 17(c), FIG. 17(d), and FIG. 17(e), three array antennas are used as an example. The three array antennas are respectively a uniform linear array antenna (denoted as an array antenna #1) whose quantity of array elements is 10, a two-dimensional coprime linear array antenna (denoted as an array antenna #2) whose quantity of array elements is 6, and a three-dimensional coprime linear array antenna (denoted as an array antenna #3) corresponding to Combination 5.

In a case, as shown in FIG. 17(a), 10 signals from different directions are received by using the array antenna #1. In this case, 10 DOAs corresponding to the 10 signals may be estimated by using a MUSIC algorithm. As shown in FIG. 17(b), the 10 signals from different directions are received by using the array antenna #3. In this case, the 10 DOAs corresponding to the 10 signals may be also estimated by using the MUSIC algorithm.

In another case, as shown in FIG. 17(c) and FIG. 17(d), 40 signals from different directions are received by using the array antenna #1 and the array antenna #2. In this case, because a quantity of received signals is greater than a maximum quantity of DOAs that can be estimated by using the array antenna #1 and the array antenna #2, 40 DOAs corresponding to the 40 signals cannot be estimated by using a MUSIC algorithm. However, as shown in FIG. 17(e), the 40 signals from different directions are received by using the array antenna #3. In this case, because the quantity of received signals is less than a maximum quantity of DOAs that can be estimated by using the array antenna #3, the 40 DOAs corresponding to the 40 signals can still be estimated by using the MUSIC algorithm.

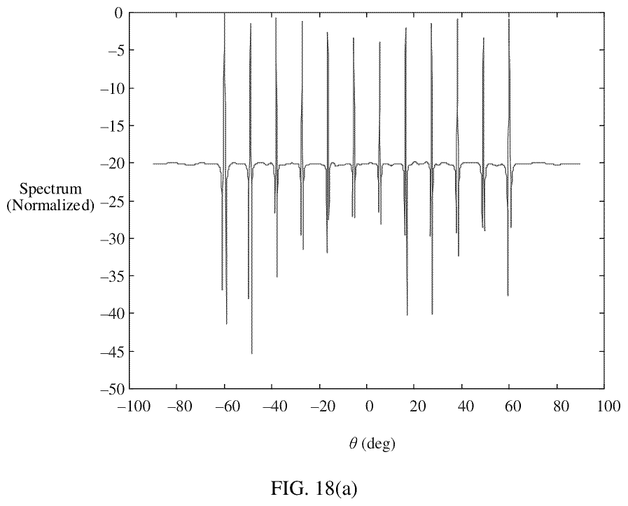

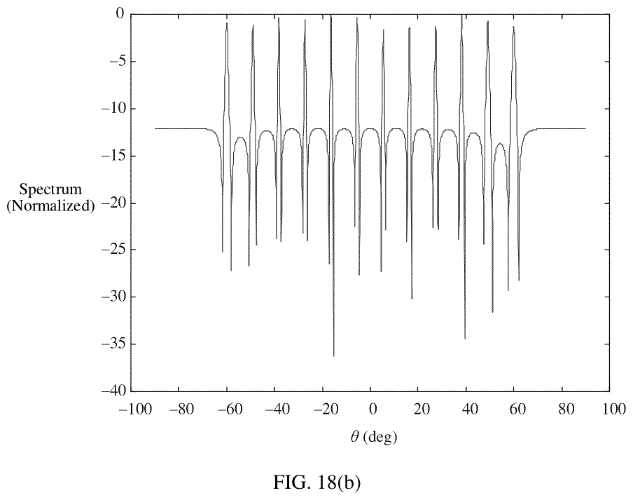

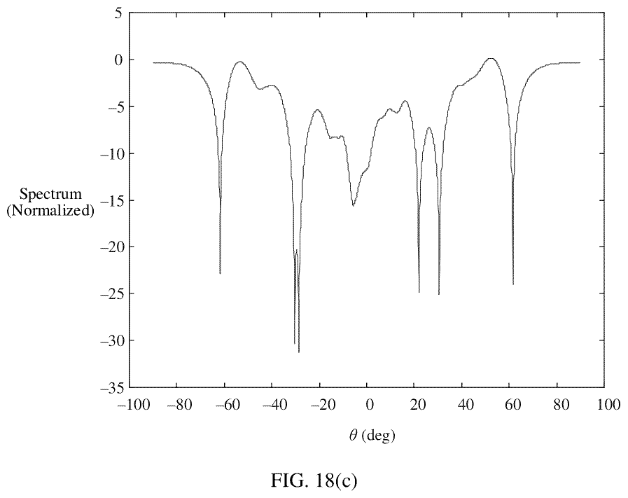

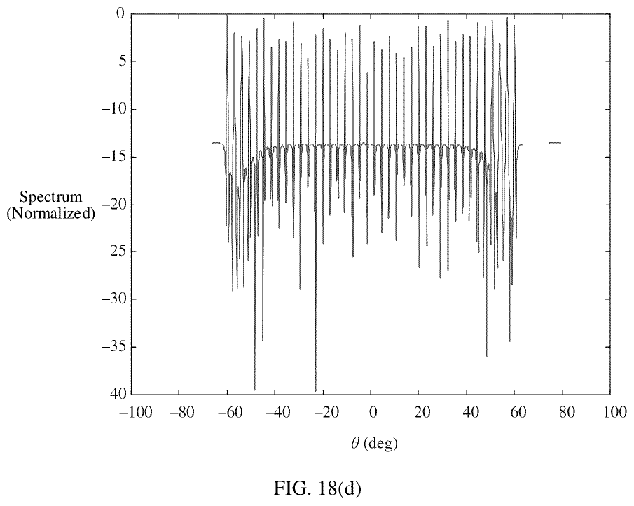

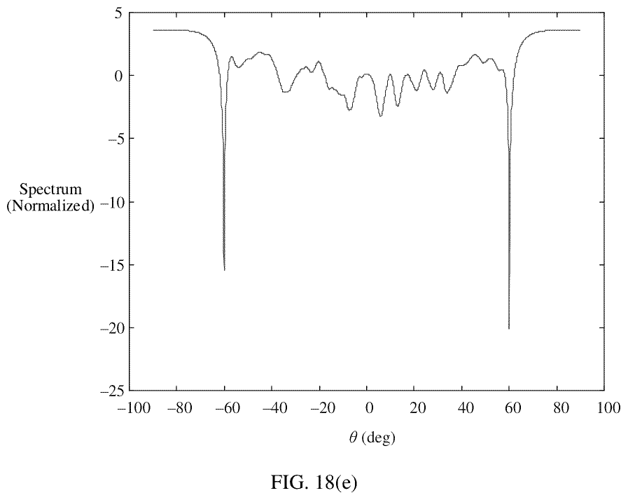

FIG. 18(a), FIG. 18(b), FIG. 18(c), FIG. 18(d), and FIG. 18(e) are a diagram 2 of simulation of DOA estimation. As shown in FIG. 18(a), FIG. 18(b), FIG. 18(c), FIG. 18(d), and FIG. 18(e), three array antennas are still used as an example. The three array antennas are respectively the foregoing array antenna #1, array antenna #2, and array antenna #3.

In a case, as shown in FIG. 18(a), 10 signals from different directions are received by using the array antenna #1. In this case, 10 DOAs corresponding to the 10 signals may be estimated by using an MVDR algorithm. As shown in FIG. 18(b), the 10 signals from different directions are received by using the array antenna #3. In this case, the 10 DOAs corresponding to the 10 signals may be also estimated by using the MVDR algorithm.

In another case, as shown in FIG. 18(c) and FIG. 18(d), 40 signals from different directions are received by using the array antenna #1 and the array antenna #2. In this case, because a quantity of received signals is greater than a maximum quantity of DOAs that can be estimated by using the array antenna #1 and the array antenna #2, 40 DOAs corresponding to the 40 signals cannot be estimated by using an MVDR algorithm. However, as shown in FIG. 18(e), the 40 signals from different directions are received by using the array antenna #3. In this case, because the quantity of received signals is less than a maximum quantity of DOAs that can be estimated by using the array antenna #3, the 40 DOAs corresponding to the 40 signals can still be estimated by using the MVDR algorithm.

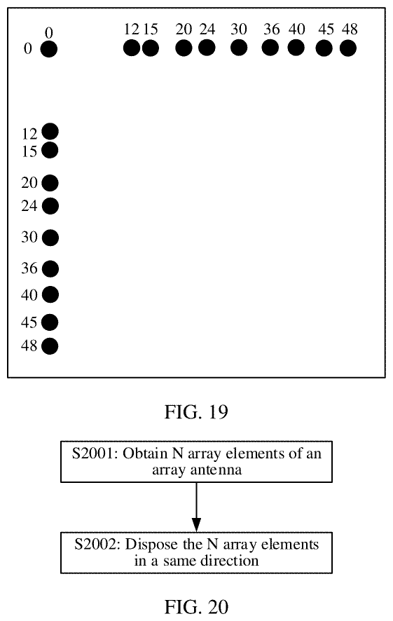

In addition, with reference to FIG. 17(a), FIG. 17(b), FIG. 17(c), FIG. 17(d), and FIG. 17(e), and FIG. 18(a), FIG. 18(b), FIG. 18(c), FIG. 18(d), and FIG. 18(e), it can be further seen that when the quantity of array elements does not significantly differ from that of an array antenna in a conventional technology, the array antenna in embodiments of this application can significantly increase a quantity of estimated DOAs, and can further consider DOA estimation precision. The array antenna may be used in a plurality of scenarios in multiple-input multiple-output (MIMO) communication/a multiple-input multiple-output radar, for example, applications such as a sonar, seismic wave detection, positioning and tracking, and a vehicle-mounted millimeter wave radar. For example, as shown in FIG. 19, the array antenna in embodiments of this application may be used in a MIMO communication scenario. The array antenna may be a coprime L-shaped array antenna, or an array antenna in any other possible form, for example, a coprime planar array or a coprime circular array. This is not limited.

In conclusion, the spacing between the i^{th} array element and the reference position is a unit length multiplied by the product of the N−1 positive integers, in other words, a unit length multiplied by a product of at least two positive integers. Therefore, compared with a conventional coprime array antenna, the array antenna includes array antennas with an increased array element spacing, where the array elements may be disposed more sparsely. Therefore, the array antenna may be equivalent to a linear array with more array elements, for example, a uniform linear array antenna, to estimate a large quantity of DOAs.

The foregoing describes the array antenna provided in embodiments of this application with reference to FIG. 7 to FIG. 19. The following describes a method for manufacturing an array antenna with reference to FIG. 20.

As shown in FIG. 20, a procedure of the method for manufacturing an array antenna may include the following steps.

S2001: Obtain N array elements of the array antenna.

S2002: Dispose the N array elements in a same direction.

N is an integer greater than or equal to 3. A spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

In addition, for a principle of the array antenna in the method shown in FIG. 20, refer to the related descriptions in FIG. 7 to FIG. 19. Details are not described herein again.

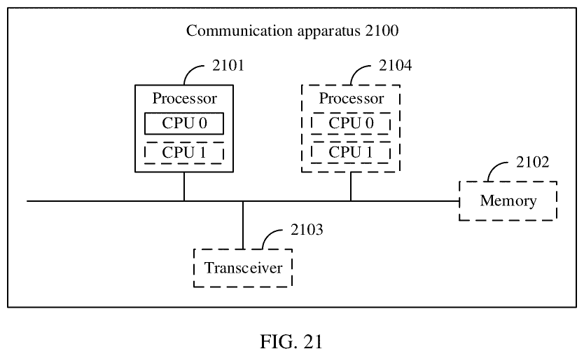

FIG. 21 is a diagram of a structure of a communication apparatus according to an embodiment of this application. For example, the communication apparatus may be a terminal, or may be a chip (or system) or another part or component that can be disposed in the terminal. As shown in FIG. 21, the communication apparatus 2100 may include a processor 2101. Optionally, the communication apparatus 2100 may further include a memory 2102 and/or a transceiver 2103. The processor 2101 is coupled to the memory 2102 and the transceiver 2103, for example, the processor 2101, the memory 2102, and the transceiver 2103 may be connected through a communication bus.

The following describes each component of the communication apparatus 2100 with reference to FIG. 21.

The processor 2101 is a control center of the communication apparatus 2100, and may be a processor, or may be a general name of a plurality of processing elements. For example, the processor 2101 is one or more central processing units (CPUs), may be an application-specific integrated circuit (ASIC), or is configured as one or more integrated circuits for implementing embodiments of this application, for example, one or more digital signal processors (DSPs) or one or more field programmable gate arrays (FPGAs).

Optionally, the processor 2101 may perform various functions of the communication apparatus 2100 by running or executing a software program stored in the memory 2102 and invoking data stored in the memory 2102, for example, perform the foregoing method shown in FIG. 20.

During implementation, in an embodiment, the processor 2101 may include one or more CPUs, for example, a CPU 0 and a CPU 1 shown in FIG. 21.

During implementation, in an embodiment, the communication apparatus 2100 may alternatively include a plurality of processors, for example, the processor 2101 and a processor 2104 shown in FIG. 21. Each of the processors may be a single-core processor (single-CPU), or may be a multi-core processor (multi-CPU). The processor herein may be one or more devices, circuits, and/or processing cores configured to process data (for example, computer program instructions).

The memory 2102 is configured to store the software program for executing the solutions of this application, and the processor 2101 controls the execution. For a implementation, refer to the foregoing method embodiment. Details are not described herein again.

Optionally, the memory 2102 may be a read-only memory (ROM) or another type of static storage device that can store static information and instructions, or a random access memory (RAM) or another type of dynamic storage device that can store information and instructions, or may be an electrically erasable programmable read-only memory (EEPROM), a compact disc read-only memory (CD-ROM) or another compact disc storage, an optical disk storage (including a compact disc, a laser disc, an optical disc, a digital versatile disc, a Blu-ray disc, or the like), a magnetic disk storage medium or another magnetic storage device, or any other medium that can be configured to carry or store expected program code in a form of instructions or a data structure and that can be accessed by a computer. However, this is not limited thereto. The memory 2102 may be integrated with the processor 2101, or may exist independently, and is coupled to the processor 2101 by using an interface circuit (not shown in FIG. 21) of the communication apparatus 2100. This is not limited in this embodiment of this application.

The transceiver 2103 is configured to communicate with another communication apparatus. For example, the communication apparatus 2100 is the terminal, and the transceiver 2103 may be configured to: communicate with a network device or communicate with another terminal device. For another example, the communication apparatus 2100 is a network device, and the transceiver 2103 may be configured to: communicate with a terminal or communicate with another network device.

Optionally, the transceiver 2103 may include a receiver and a transmitter (not separately shown in FIG. 21). The receiver is configured to implement a receiving function, and the transmitter is configured to implement a sending function.

Optionally, the transceiver 2103 may be integrated with the processor 2101, or may exist independently, and is coupled to the processor 2101 by using the interface circuit (not shown in FIG. 21) of the communication apparatus 2100. This is not limited in this embodiment of this application.

It may be understood that the structure of the communication apparatus 2100 shown in FIG. 21 does not constitute a limitation on the communication apparatus. An actual communication apparatus may include more or fewer parts than those shown in the figure, combine some parts, or have different part arrangement.

In addition, for technical effects of the communication apparatus 2100, refer to the technical effects of the method in the foregoing method embodiment. Details are not described herein again.

An embodiment of this application further provides a chip or a chip system, where the chip or the chip system may include an input/output interface and a processing circuit. The input/output interface is configured to exchange information or data, and the processing circuit is configured to run instructions, to enable, to perform the method shown in FIG. 20, an apparatus on which the chip or the chip system is installed.

It should be understood that the processor in embodiments of this application may be a central processing unit (CPU), or the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any regular processor or the like.

It may be understood that the memory in embodiments of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through an example rather than a limitative description, random access memories (RAMs) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

All or a part of the foregoing embodiments may be implemented using software, hardware (for example, a circuit), firmware, or any combination thereof. When the software is used to implement embodiments, the foregoing embodiments may be implemented completely or partially in a form of a computer program product. The computer program product includes one or more computer instructions or computer programs. When the computer instructions or the computer programs are loaded and executed on a computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium that can be accessed by the computer, or a data storage device like a server or a data center, integrating one or more usable media. The usable medium may be a magnetic medium (for example, a floppy disk, a hard disk drive, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: Only A exists, both A and B exist, and only B exists, where A and B may be singular or plural. In addition, the character “/” in this specification generally indicates an “or” relationship between the associated objects, but may also indicate an “and/or” relationship. For details, refer to the context for understanding.

In this application, “at least one” means one or more, and “a plurality of” means two or more. “At least one of the following items (pieces)” or a similar expression thereof indicates any combination of these items, including any combination of single items (pieces) or plural items (pieces). For example, at least one item (piece) of a, b, or c may indicate: a, b, c, a and b, a and c, b and c, or a, b, and c, where a, b, and c may be singular or plural.

It should be understood that sequence numbers of the foregoing processes do not mean execution sequences in various embodiments of this application. The execution sequences of the processes should be determined based on functions and internal logic of the processes, and should not constitute any limitation on the implementation processes of embodiments of this application.

A person of ordinary skill in the art may be aware that in combination with the examples described in embodiments disclosed in this specification, units and algorithm steps can be implemented by electronic hardware or a combination of computer software and the electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that for convenient and brief description, for an operating process of the foregoing system, apparatus, and unit, refer to a corresponding process in the foregoing method embodiment. Details are not described herein again.

In the several embodiments provided in this application, it should be understood that the disclosed system, apparatus, and method may be implemented in other manners. For example, the apparatus embodiments described above are merely examples. For example, division into the units is merely logical function division and may be another division manner during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. A part or all of the units may be selected based on an actual requirement to achieve the objectives of the solutions of embodiments.

In addition, functional units in embodiments of this application may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to a conventional technology, or a part of the technical solutions may be implemented in a form of a software product. The computer software product is stored in a storage medium, and includes several instructions for instructing a computing device (which may be a personal computer, a server, a network device, or the like) to perform all or a part of the steps of the methods described in embodiments of this application. The foregoing storage medium includes any medium that can store program code, like a USB flash drive, a removable hard disk drive, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An array antenna, wherein the array antenna comprises N array elements disposed in a same direction, and N is an integer greater than or equal to 3, wherein
a spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

2. The array antenna according to claim 1, wherein the N array elements comprise a first array element, a second array element, and a third array element, wherein
a spacing between the first array element and the reference position is M₁ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, Mᵢ is a product of J₂ and J₃, M₂ is a product of J₁ and J₃, M₃ is a product of J₁ and J₂, and any two integers in J₁, J₂, and J₃ are prime numbers of each other.

3. The array antenna according to claim 2, wherein a product of J₁, J₂, and J₃ is positively correlated with a quantity of beams of the array antenna, and the quantity of beams of the array antenna is a quantity of beams transmitted or received by the array antenna.

4. The array antenna according to claim 3, wherein the product of J₁, J₂, and J₃ is positively correlated with a quantity of array elements of a linear array equivalent to the array antenna, and the quantity of array elements of the linear array is positively correlated with the quantity of beams of the array antenna.

5. The array antenna according to claim 4, wherein the quantity of array elements of the linear array is K, and that the product of J₁, J₂, and J₃ is positively correlated with the quantity of array elements of the linear array means that K=2*J₁*J₂*J₃+1.

6. The array antenna according to claim 5, wherein that the quantity of array elements of the linear array is positively correlated with the quantity of beams of the array antenna means that the quantity of beams of the array antenna is K-1.

7. The array antenna according to claim 2, wherein values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

8. A method for manufacturing an array antenna, wherein the method comprises:
obtaining N array elements of the array antenna, wherein N is an integer greater than or equal to 3; and
disposing the N array elements in a same direction, wherein a spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

9. The method according to claim 8, wherein the N array elements comprise a first array element, a second array element, and a third array element, and the disposing the N array elements in a same direction comprises:
disposing the first array element, the second array element, and the third array element in the direction, wherein a spacing between the first array element and the reference position is Mᵢ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, Mᵢ is a product of J₂ and J₃, M₂ is a product of J₁ and J₃, M₃ is a product of J₁ and J₂, and any two integers in J₁, J₂, and J₃ are prime numbers of each other.

10. The method according to claim 9, wherein a product of J₁, J₂, and J₃ is positively correlated with a quantity of beams of the array antenna, and the quantity of beams of the array antenna is a quantity of beams transmitted or received by the array antenna.

11. The method according to claim 10, wherein the product of J₁, J₂, and J₃ is positively correlated with a quantity of array elements of a linear array equivalent to the array antenna, and the quantity of array elements of the linear array is positively correlated with the quantity of beams of the array antenna.

12. The method according to claim 11, wherein the quantity of array elements of the linear array is K, and that the product of J₁, J₂, and J₃ is positively correlated with the quantity of array elements of the linear array means that K=2*J₁*J₂*J₃+1.

13. The method according to claim 12, wherein that the quantity of array elements of the linear array is positively correlated with the quantity of beams of the array antenna means that the quantity of beams of the array antenna is K-1.

14. The method according to claim 9, wherein values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

15. An antenna panel, comprising a plurality of array antennas, wherein each array antenna of the array antennas comprises N array elements disposed in a same direction, and N is an integer greater than or equal to 3, wherein
a spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

16. The antenna panel according to claim 15, wherein the N array elements comprise a first array element, a second array element, and a third array element, wherein
a spacing between the first array element and the reference position is M₁ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, Mᵢ is a product of J₂ and J₃, M₂ is a product of J₁ and J₃, M₃ is a product of J₁ and J₂, and any two integers in J₁, J₂, and J₃ are prime numbers of each other.

17. The antenna panel according to claim 16, wherein a product of J₁, J₂, and J₃ is positively correlated with a quantity of beams of the array antenna, and the quantity of beams of the array antenna is a quantity of beams transmitted or received by the array antenna.

18. The antenna panel according to claim 17, wherein the product of J₁, J₂, and J₃ is positively correlated with a quantity of array elements of a linear array equivalent to the array antenna, and the quantity of array elements of the linear array is positively correlated with the quantity of beams of the array antenna.

19. The antenna panel according to claim 18, wherein the quantity of array elements of the linear array is K, and that the product of J₁, J₂, and J₃ is positively correlated with the quantity of array elements of the linear array means that K=2*J₁*J₂*J₃+1.

20. The antenna panel according to claim 19, wherein that the quantity of array elements of the linear array is positively correlated with the quantity of beams of the array antenna means that the quantity of beams of the array antenna is K-1.

21. The antenna panel according to claim 16, wherein values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.

22. The antenna panel according to claim 15, wherein the plurality of array antennas are disposed in different directions.

23. A communication apparatus, comprising a processor, wherein the processor is configured to perform:
obtaining N array elements of the array antenna, wherein N is an integer greater than or equal to 3; and
disposing the N array elements in a same direction, wherein a spacing between an i^{th} array element in the N array elements and a reference position in the direction is Mᵢ times a unit length, i is any integer from 1 to N, half wavelengths of the N array elements are the same, the unit length is a positive integer multiple of the half wavelength, the N array elements are in one-to-one correspondence with N positive integers, any two of the N positive integers are prime numbers of each other, Mᵢ is a product of N−1 positive integers, and the N−1 positive integers are integers other than a positive integer corresponding to the i^{th} array element in the N positive integers.

24. The communication apparatus according to claim 23, wherein the N array elements comprise a first array element, a second array element, and a third array element, and the disposing the N array elements in a same direction comprises:
disposing the first array element, the second array element, and the third array element in the direction, wherein a spacing between the first array element and the reference position is Mᵢ times the unit length, a spacing between the second array element and the reference position is M₂ times the unit length, a spacing between the third array element and the reference position is M₃ times the unit length, a positive integer corresponding to the first array element is J₁, a positive integer corresponding to the second array element is J₂, a positive integer corresponding to the third array element is J₃, Mᵢ is a product of J₂ and J₃, M₂ is a product of J₁ and J₃, M₃ is a product of J₁ and J₂, and any two integers in J₁, J₂, and J₃ are prime numbers of each other.

25. The communication apparatus according to claim 24, wherein a product of J₁, J₂, and J₃ is positively correlated with a quantity of beams of the array antenna, and the quantity of beams of the array antenna is a quantity of beams transmitted or received by the array antenna.

26. The communication apparatus according to claim 25, wherein the product of J₁, J₂, and J₃ is positively correlated with a quantity of array elements of a linear array equivalent to the array antenna, and the quantity of array elements of the linear array is positively correlated with the quantity of beams of the array antenna.

27. The communication apparatus according to claim 26, wherein the quantity of array elements of the linear array is K, and that the product of J₁, J₂, and J₃ is positively correlated with the quantity of array elements of the linear array means that K=2*J₁*J₂*J₃+1.

28. The communication apparatus according to claim 27, wherein that the quantity of array elements of the linear array is positively correlated with the quantity of beams of the array antenna means that the quantity of beams of the array antenna is K-1.

29. The communication apparatus according to claim 24, wherein values of J₁, J₂, and J₃ meet at least one combination of the following: J₁=2, J₂=3, and J₃=5; J₁=2, J₂=3, and J₃=7; J₁=2, J₂=3, and J₃=11; J₁=2, J₂=5, and J₃=7; J₁=3, J₂=4, and J₃=5; or J₁=3, J₂=4, and J₃=7.
